(19) United States
(12) Patent Application Publication
(10) Pub. No.: US 2014/0289164 A1
(43) Pub. Date: Sep. 25, 2014

(54) Trading Platform for Invoice Spread Products

(71) Applicant: trueEX Group LLC, New York, NY (US)

(72) Inventor: Sunil Hirani, Greenwich, CT (US)

(73) Assignee: trueEX Group LLC, New York, NY (US)

(21) Appl. No.: 14/217,314

(22) Filed: Mar. 17, 2014

Related U.S. Application Data
(60) Provisional application No. 61/793,128, filed on Mar. 15, 2013.

(51) Int. Cl. G06Q 40/06

(52) U.S. Cl. CPC G06Q 40/06; G06Q 40/04
USPC 705/36 R

(57) ABSTRACT

A system and method for providing improved functionality to an invoice spread swap platform includes functionality for determining parameters associated with a potential invoice spread swap transaction, such as automated determination of swap and bond DVO1 values, as well as normalizes the transaction notional amount as a result of the calculated DVO1 values. The system may also be implemented in a method of implementing invoice spread swap transactions, as well as computer instructions which when executed implement invoice spread swap transactions including automated determination of swap and bond DVO1 values, as well as normalizes the transaction notional amount as a result of the calculated DVO1 values.

### PRIORITY INFORMATION

The present application is a utility application, and claims priority to the U.S. Provisional Application Ser. No. 61/793,128, filed on Mar. 15, 2013 in the name of Sunil Hirani, titled Trading Platform for Invoice Spread Products, and U.S. patent application Ser. No. 13/446,998, filed on Apr. 13, 2012 in the names of Sunil Hirani and James Miller, and titled Method and System for Interest Rate Swaps, which claims priority to the U.S. Provisional Application Ser. No. 61/517,110, filed on Apr. 13, 2011, titled Method and System for Interest Rate Swaps, Ser. No. 61/627,868, filed on Oct. 18, 2011, and titled Method and System for Interest Rate Swaps, and Ser. No. 61/686,113, filed on Mar. 29, 2012, titled Credit Limit Concept in the names of Sunil Hirani and James Miller the contents of each of which are incorporated herein in their entireties by reference thereto.

### BACKGROUND

The present disclosure relates to the provision and distribution of information regarding invoice spread products to implement efficient transactions associated with the offering and acquisition of invoice spread products, and the management of portfolios associated with invoice spread transactions.

An Invoice Spread is the simultaneous exchange of a Treasury future contract and an Interest rate Swap. As the treasury future is characterized by a fixed interest rate, the counter position is characterized by a floating interest rate, indexed to some published rate such as the LIBOR. Invoice spreads are attractive to hedge funds interested in avoiding the Balance Sheet treatment of cash Treasuries, and the Treasury repo market.

An invoice spread swap may typically not specify the specific bond desired for the counter-position, but rather characteristics of acceptable bonds, such as a range or issue for the maturity date of the bond. Accordingly, bonds which meet the characteristics may be prioritized for use as the counter position based on the characteristics of the available bonds themselves (referred to as the basket of bonds, i.e., the group of bonds available for use as a counter position). At the time of execution the bonds may be prioritized such that the cheapest-to-delivery bond (CTD) is specified and that bond's yield is calculated based on the futures price. The spread (the number of basis points that a first party is offering for entering into the swap) is added to the treasury yield to derive the swap yield.

The risk per basis point (DV01) may be used to match the number of futures to a swap notional. The DV01 is usually agreed upon at time of trade, although sometimes the number of futures or swap notional may be specified. The risk of the swap is calculated and the corresponding amount of notional is confirmed on the trade, rounded to nearest $100K. An equivalent risk amount of treasury futures are exchanged to match this risk, rounded to nearest contract. Since this is a forward starting swap, OIS discounting should be used. An entity buying the spread will be a payer in the swap and a buyer of treasuries futures.

As time passes and the variable interest rate fluctuates, a different bond may become the CTD as a result of the maturity date of the bond or the timing of the remaining interest payments, or the bond associated with an invoice spread may grow closer to its maturity date, thus reducing the liquidity of the underlying bond as well as the liquidity of the invoice spread position. In this case, a holder may desire to adjust invoice spread products held by that holder to remove older bonds, such as off the run positions, and replace them with on the run positions, sometimes referred to as a calendar roll.

The following exemplary definitions are provided for reference in understanding the present disclosure, and while providing a general understanding of the terms, do not otherwise limit the understanding of persons of ordinary skill in the art as to the meaning and underlying understanding of those terms:

Basis Points—A unit that is equal to 1/100th of 1%, and is used to denote the change in a financial instrument. The basis point is commonly used for calculating changes in interest rates, equity indexes and the yield of a fixed-income security.

Bond—A bond is an instrument of indebtedness of the bond issuer to the holders. It is a debt security, under which the issuer owes the holders a debt and, depending on the terms of the bond, is obliged to pay them interest (the coupon) and/or to repay the principal at a later date, termed the maturity date.

Cheapest-to-Delivery (CTD)—In a futures contract, the cheapest security that can be delivered to the long position to satisfy the contract specifications. The cheapest-to-deliver security is relevant only for contracts which provide that a variety of slightly different securities may be delivered. This is common in treasury bond futures contracts, which typically specify that any treasury bond can be delivered, so long as it is within a certain maturity range and has a certain coupon rate.

Dollar Value of 1 Basis Point (DVO1)—A measure of how much a bond goes down in price in response to a 1 basis point increase in the interest rate.

Interest Rate Swap (IRS)—A highly liquid financial derivative instrument in which two parties agree to exchange interest rate cash flows, based on a specified notional amount from a fixed rate to a floating rate (or vice versa) or from one floating rate to another. Interest rate swaps may be used for both hedging and speculating.

On the Run—The most recently issued U.S. Treasury bond or note of a particular maturity. “On-the-run” Treasuries are the opposite of “off-the-run” Treasuries, which refer to Treasury securities that have been issued before the most recent issue and are still outstanding. Media mentions about Treasury yields and prices generally reference “on-the-run” Treasuries.

Off the Run—All Treasury bonds and notes issued before the most recently issued bond or note of a particular maturity. These are the opposite of “on-the-run treasuries.”

Repo Rate—The rate at which the central bank of a country lends money to commercial banks in the event of any shortfall of funds. Repo rate is used by monetary authorities to control inflation.

### SUMMARY OF THE INVENTION

In one embodiment, the present application is a system and method for providing an invoice spread products platform enabling improved trading in invoice spread products, including in simple spread transactions, as well as in allowing a platform user to maintain a portfolio of invoice spreads by enabling maturity rolls and other maintenance tasks.

In a simple form, the system of the present invention is a computer implemented platform for managing invoice spread products having a computer system including a plurality of user interfaces. The computer system is provided with interface capabilities for identifying and maintaining information regarding bond products held by platform users, including bond products which the platform user may be willing to exchange in an invoice spread transaction, as well as platform users who are seeking invoice spread transactions to effectuate. The platform may be provided with communications capabilities to allow it to present information to both platform users who are offering bond products, as well as platform users who are interested in effectuating invoice spread transactions. The platform may further include capabilities for determining cheapest to delivery bond products from bond products held by platform users in a basket of bond products, as well as capabilities for determining parameters associated with a proposed bond position with respect to a potential invoice spread swap transaction.

The present disclosure may also be embodied in a process in which an invoice spread swap platform is first established an invoice spread swap platform. The platform may then communicably connect a plurality of users to said invoice spread swap platform. The platform may receive from at least one platform user at least one bond position available for execution as a counter position in an invoice spread transaction. The platform may display for a first platform user a query allowing said first platform user to select a type of potential invoice spread transaction said platform user may desire to effectuate, then receive from said first platform user an invoice spread transaction type identifying a transaction type the first platform user may desire to effectuate. The platform may then display for the first platform user a plurality of potential basis point adjustments associated with a plurality of bond types for said transaction type. Once the potential transaction types have been displayed, the platform may receive from the first platform user identification of a desired basis point adjustment associated with a desired bond type for the selected transaction type. From the identified transaction type, the platform may next determine from the desired basis point adjustment associated with a desired bond type for the selected transaction type a cheapest to delivery bond for the bond type and transaction type, and identify the platform user offering the identified cheapest to delivery bond. The platform may next determine for the cheapest to delivery bond parameters associated with the potential transaction, and display those parameters to the first platform user, who may then be queried to determine whether said first platform user desires to effectuate the transaction involving said cheapest to delivery bond. When the first platform user indicates that he or she desires to effectuate a transaction involving said cheapest to delivery bond, the platform may communicate to the offering platform user the proposed transaction. The offering platform user may then indicate whether the offering platform user desires to effectuate the transaction, and notify the first platform user that the offering platform user is willing to effectuate the transaction. When the offering platform user indicates that he or she does not desire to effectuate said transaction, determining from the offering platform user whether he or she desires to substitute a different bond from a basket of deliverable bonds, and if so determining for the substitute bond parameters associated with the potential transaction. When the offering user desires to effectuate the transaction involving said substitute bond, informing the first platform user that said offering platform user is willing to effectuate the transaction using said substitute bond, and displaying said parameters associated with said substitute bond. The platform may next determine from the first platform user whether said the first platform user desires to confirm effectuation of said transaction when the offering platform user indicates a willingness to effectuate the potential transaction involving either said cheapest to delivery bond or a substitute bond, and, when the first platform user confirms effectuation of said transaction, updating the transaction records and portfolio lists of the first platform user and the offering platform user to effectuate the transaction, and, settling the transaction through appropriate channels for the first platform user and the offering platform user.

### BRIEF DESCRIPTION OF THE FIGURES

FIG. 1, comprising Sheets 1 and 1B, illustrates a simplified method for implementing an invoice spread trade on an invoice spread platform according to an embodiment of the present disclosure.

FIG. 2 illustrates a notional display of potential bond positions for a simple invoice spread transaction.

FIG. 3 illustrates a notional display of potential bond positions associated with a calendar roll invoice spread transaction.

FIG. 4 illustrates a notional display of potential bond positions associated with a spot switch transaction.

FIG. 5 illustrates a notional display of potential bond positions associated with invoice curve switch transactions.

FIG. 6 illustrates a system diagram for an apparatus for implementing an embodiment of the present disclosure.

### DETAILED DESCRIPTION OF THE INVENTION

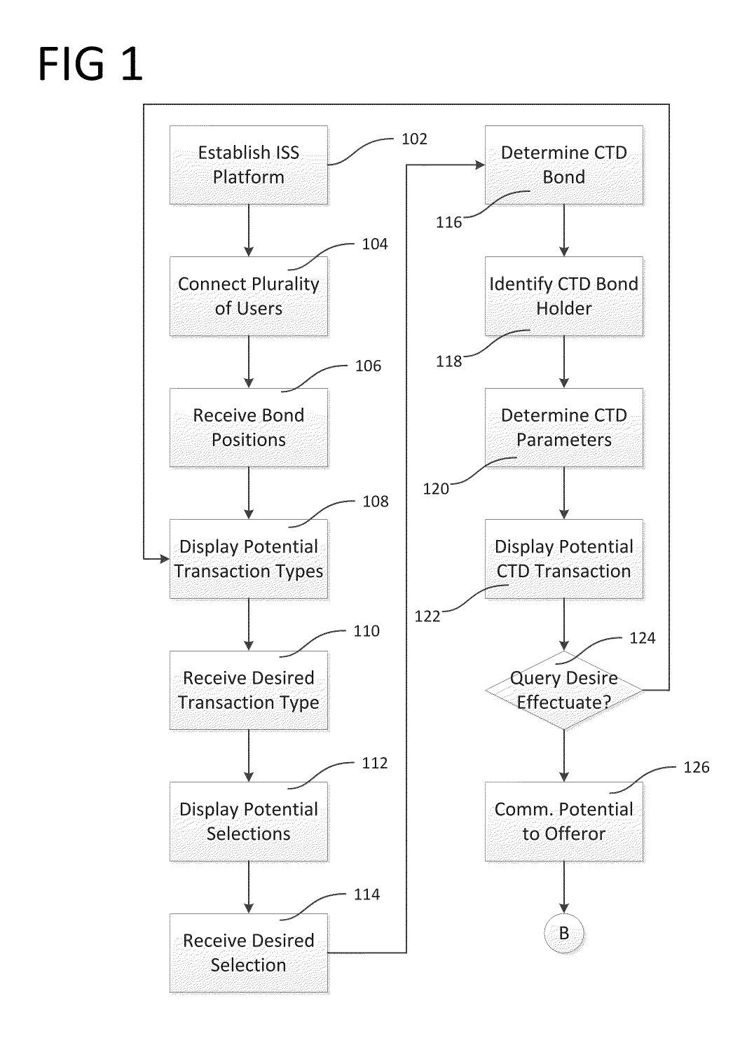

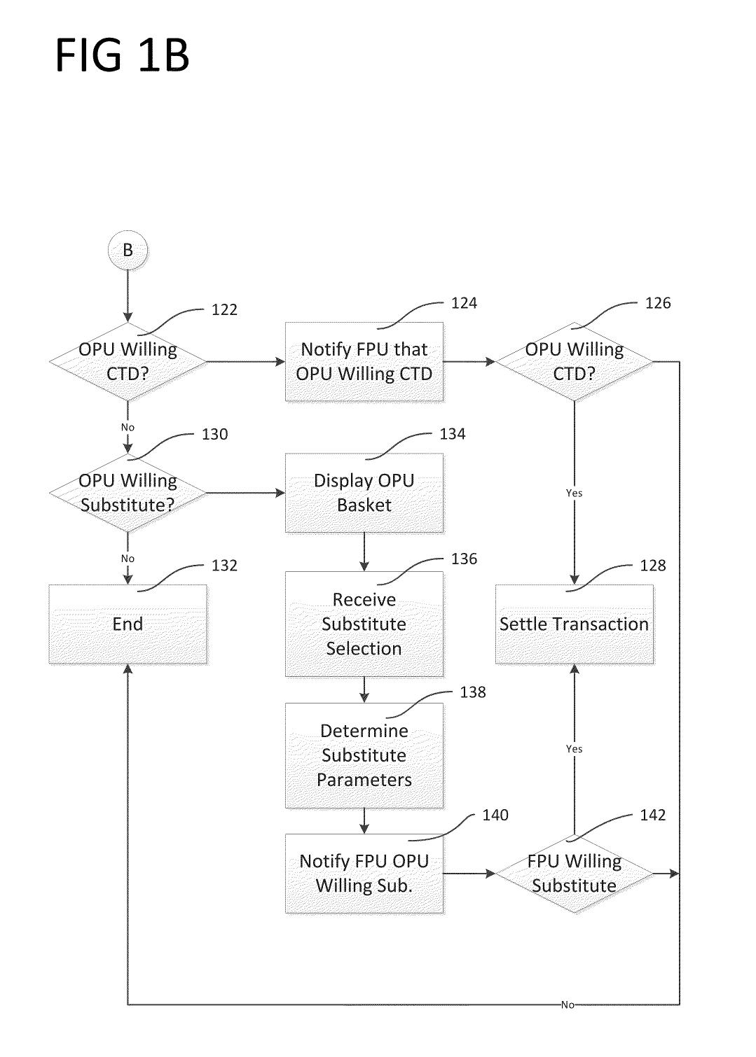

As shown in the figures, in which like numerals are used to identify like elements, there is shown an embodiment of the present invention. FIG. 1 shows a basic method 100 for implementing invoice spread products in accordance with an embodiment of the present disclosure. At the outset, an invoice spread swap (ISS) platform may be established 102. Multiple users may be communicably connected 104 to the platform. The users may be characterized based on their role at a particular moment, i.e, some users may have bonds available for inclusion in an invoice spread swap, and are hereafter referred to as “offering platform users,” while other users may be interested in entering in to an invoice spread swap with a bond as the counter position (referred to herein as “first platform users”). As the invoice spread may have immediate financial effects for both the requesting party as well as the exchanging party, both parties may be required to be pre-approved for entering into an exchange of an invoice spread exchange. Accordingly, an initial step may be to determine the eligibility of the platform user to enter into the transaction.

Information identifying bonds held by offering platform users may be received 106 by the platform. This information may be received as a result of the offering platform user having provided the information to the platform as part of services received by the offering platform user from the platform, such as access to management tools, or through recordation of past transactions of the offering platform user. Alternately, the offering platform user may simply provide the information to the platform. In any case, the platform may store the information in a database, such that the information identifying bonds held by an offering platform user is available for reference to both the offering platform user as well as to the platform itself for consideration as a bond eligible to be the counter position for an invoice spread.

A transaction may be initiated by the platform displaying 108 potential transaction types to a first platform user. The transaction types may include, but are not limited to, simple invoice swaps, calendar rolls, and/or other forms as discussed below. The first platform user may indicate a desired transaction type, with that desired transaction type being received 110 by the platform.

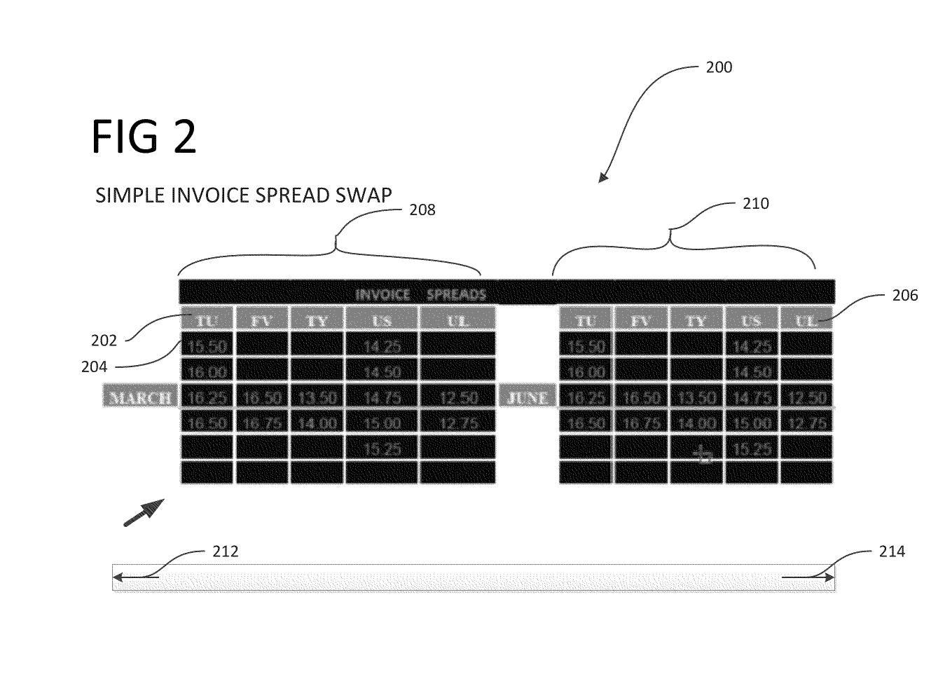

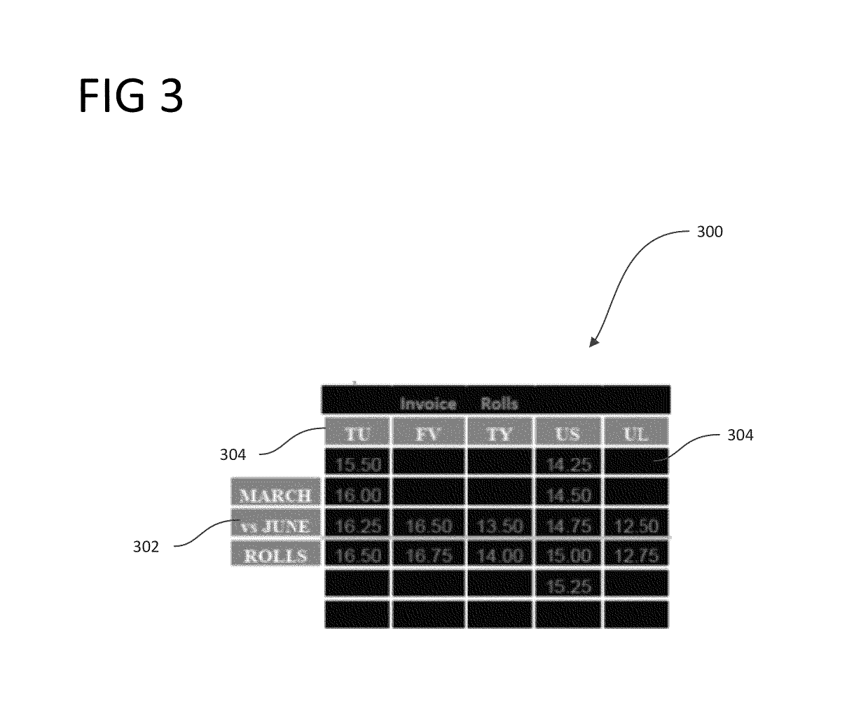

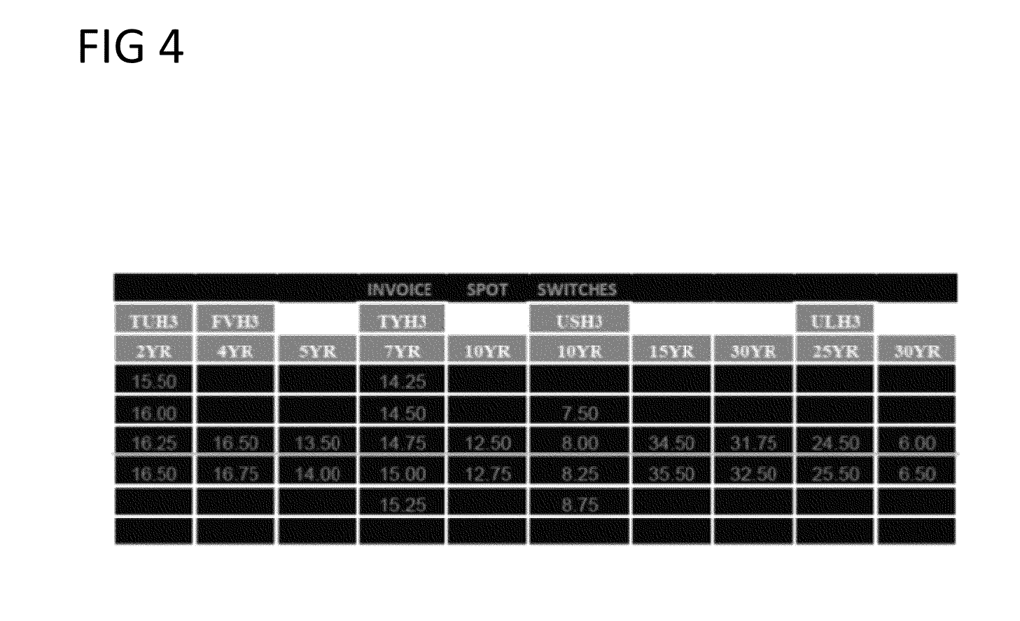

Based on the transaction type selected by the first platform user, the platform may generate a display of potential invoice spreads, including, for example, available bond ranges to consider, as well as basis points to be offered as part of the invoice spread swap. A notional display for a simple invoice spread swap is shown in FIG. 2. The information presented 200 to the platform user may be a combination of potential counter positions/bonds 202, as well as the basis points 204 associated with entering into an agreement based on such position. The display may be ordered such that the options for the associated bonds are shown as column headings 206, with separate sections 208, 210 identifying delivery options for on the run invoice spreads. Optionally, the display may be implemented such that it can scroll through a broader range of possible positions through the provision of left 212 and right 214 arrows to indicate a desire to scroll the display as needed to view additional potential positions. The first platform user may be able to use a cursor or arrow 216 as a pointer to indicate and select a potential position for consideration as the basis for effecting an invoice swap spread.

Returning to FIG. 1, from the generated display, the platform user may select a position as the activity or trade to initiate. Initiation may be actuated by a platform user identifying a particular basis point value for a selected invoice spread product.

Once the platform user has received 112 a basis point position and invoice spread, the platform may analyze available invoice spreads to identify 116 the cheapest-to-deliver (“CTD”) position. For the counter swap, the process may identify a CTD position from available positions, including bonds held by the platform operator, as well as bonds held by other potential counterparties who are also platform users. In such an embodiment, the CTD position would be a bond in the deliverable basket having the highest implied repo rate, with the delivery basket not necessarily being limited to the available bonds from a single potential counterparty platform user. The repo rate for products may be set by a platform market committee at the time of the listing of the invoice spread product. The platform may also identify 118 the offering holder or holders associated with the CTD bond, such that the transaction may be implemented and settled if both parties agree to effectuate the transaction.

For the proposed swap, the parameters of the CTD swap may be determined 120. The start date for the swap may be set as the last intention day of the corresponding futures contract or bond. The end date for the swap may be set to be the maturity date of the CTD position. Where an uneven period arises, i.e., the CTD position has an initiation date other than the current date, the front coupon stub may be used to apply a correction for the interest amount for the initial period.

Based on the information thus obtained and derived, the process may then calculate the par swap dV01 for the CTD product, and calculate the swap notional by dividing the bond DV01 by the swap DV01.

The system may use a set of benchmark invoice spreads to provide a manageable number of invoice spreads to be available. The benchmark invoice spreads may include one or more of the following:

Tenors: TU (1.75-2 YRS), 3 YR (2.75-3 YRS), FV (4-5.25 YRS), TY (6.5-10 YRS), US (15-25 YRS), UL (25+YRS);

Effective Series: quarterly series starting March, June, September, and December;

Available Series: next 2 quarterly series (On the run);

Trading Size: same as spot swap spreads;

Trading Price: spread price using swap over CTD yield convention in 0.25 bp increments;

Trading Hours: 8 am to 4 pm NY time, Monday-Friday for non-NY holidays;

Last Trading Date and Time: 4 pm 2 business days before last

Intention day or swap effective date, whichever comes first.

a) For 2 yr, 3 yr and 5 yr is the first business day of the next following calendar month

b) For all others it is 2^{nd} business day before the last business day of the delivery month;

First Trading Date: a new invoice series will be listed the same day spot series is moved to off-the-run;

Underlying CTD: Set by offeror at time of announcement. In case treasury curve moves substantially, the offeror has the option to list another Invoice Spread with different CTD for the same series. The prior Spread will be moved to off-the-run trading;

New CTD Announcements: New CTD spreads will be announced at approximately 4 pm the day before it is listed for trading;

Daily Settlement: 3 pm NY time based on trading and quote levels or model prices if there is a lack of liquidity. The same methodology as ordinary interest rate swaps may be implemented.

As an example of the above process, a platform user may identify a TYU2 (6.5-10 year bond) product, currently trading at 134-01+. The last intention day for the bond may be Sep. 28, 2012. For 2 yr, 3 yr and 5 yr bonds, the last intention day may be set as the first business day of the next following calendar month. For all other maturity dates it is 2nd business day before the last business day of the delivery month.

The cheapest-to-delivery (CTD) process may identify a bond paying 3.125% fixed interest, maturing on May 15, 2019, for example. The conversion factor, for any particular bond deliverable into a futures contract, is a number by which the bond futures delivery settlement price is multiplied, to arrive at the delivery price for that bond. For this example, the conversion factor for the identified bond may be 0.8471. The implied forward price for the bond would be 113.5511, and the implied forward yield would be 0.870%. From this, the bond DVO1 per MM would be 694, while the swap DVO1 would be 679.07 (par swap Sep. 28, 2012 to May 15, 2019). The swap notional would be 120.6 MM=$100,000/contract*1,000 contracts*694/.8471/679.07. These parameters would be displayed for the platform user, with the platform user then provided with the option of requesting the swap.

The proposed swap can then be displayed 122 for the platform user to determine whether the platform user desires to implement the proposed swap. A desire to implement the proposed invoice spread swap may be indicated by the first platform user selecting a continue button on the display of parameters, or though other similar means.

If the first platform user desires to effectuate the transaction, the delivery parameters of the proposed swap may be communicated 126 to the holder of the proposed CTD bond, who may agree to execute the swap based on the identified bond, may propose a different bond from a basket of bonds held by the counterparty, or may decline the transaction. The counterparty to the proposed swap may be the exchange itself, or a different platform user on the platform. The counterparty will typically have more than one potential bond for involvement in a proposed invoice spread, such that the preferable bond to transact is usually the CTD bond.

The design of bond futures contracts purposely avoids a single underlying security. One reason is to ensure that the liquidity of the futures contract does not depend on the liquidity of a single, underlying bond, which might lose its liquidity for idiosyncratic reasons, e.g., being accumulated by a few large, buy-and-hold investors. Another reason for avoiding a single underlying bond is to avoid losing liquidity to the threat of a squeeze. A trader squeezes a contract by simultaneously purchasing many contracts and a large fraction of a deliverable bond issue, hoping to sell the position at a profit as traders who had sold the contract scramble to buy the bond to make delivery or, failing that, to buy back the contracts they had sold. The threat of a squeeze can prevent a contract from attracting volume and liquidity by making shorts hesitant to take positions.

The existence of a basket of securities effectively avoids the problems of a single deliverable if the cost of delivering the next to CTD is not that much higher than the cost of delivering the CTD. For example, the difference between the cost of delivering the next to CTD and the cost of delivering the CTD (i.e., zero) may be only 1.3 cents per 100 face amount. Therefore, if the CTD cannot be economically purchased, because they have lost liquidity or because they are the target of a squeeze, the harm to shorts is limited to 1.3 cents: for any larger cost of acquiring the CTD, shorts would purchase and deliver the next to CTD, instead.

If the offering platform user indicates a desire to effectuate the transaction with the CTD bond, the first platform user may be notified 124 of the offering platform user's willingness to effectuate the transaction, and provided with a final operate to execute of cancel the transaction. If the first platform user indicates 126 a desire to effectuate the transaction, the platform may settle the transaction using conventional delivery options and routings.

Daily Settlement for each invoice spread may be based on trading activity at 3 pm NY time. If there is a lack of market activity at time of closing a settlement committee, formed to establish switch levels of invoice spreads to relevant benchmark swap spreads, may poll an external market advisory council to provide disinterested values for the switch levels of invoice spreads to relevant benchmark swap spreads. The settlement may add these switch levels to benchmark swap spreads to come up with the daily settlements.

If the offering platform user indicates that he or she is unwilling to implement the transaction with the CTD, the offering platform user may be queried 130 to determine whether the offering platform user desires to substitute a different bond meeting the requested parameters for the CTD bond. If the offering platform user is not willing to implement the proposed swap using the CTD bond or a substitute bond, the transaction may end, or alternately the platform may identify an alternate offering platform user holding the CTD bond position, and transmit the proposed transaction to them for consideration.

If the offering platform user desires to substitute a different bond for the CTD bond, the basket of bond positions associated with the offering platform user may be displayed 134 for the offering platform user. The offering platform user may select a substitute bond for inclusion in the transaction, which selection may be received 136 by the platform. The platform would then determine 138 the parameters associated with the substitute bond, and notify 140 the first platform user of the desire of the offering platform user to implement the transaction with the substitute bond, as well as display the parameters associated with the substitute bond position. The platform may then query 142 the first platform user to determine whether the first platform user is willing to effectuate the transaction. If the first platform user is willing to effectuate the transaction, the platform may settle 128 the transaction as discussed previously and in the priority documents. If the first platform user is unwilling to finalize the transaction, the process may end 132.

As part of the effectuation of the transaction, the platform may additionally generate confirmation messages for the first platform user and the offering platform user, informing them of the parameters of the transaction. These messages may be of the forms shown below for illustration and non-limiting purposes:

Swap Confirm for Invoice Buyer

Client pays fixed 1.22% on 120.6 MM Semi-Bond USD Swap/pays Libor 3M START DATE: Sep. 28, 2012

END DATE: May 15, 2019

Futures Confirm for Invoice Buyer

Client Buys 1000 TYU2 @134-01+

While the above illustrates the process for on the run bond positions, the platform may allow users to trade spreads that are calculated from bonds not currently the CTD, but are in the delivery basket. Most importantly are those that have been listed by the platform/exchange in the past, such as prior CTD bonds.

The platform may also allow implementation of block trades, using similar rules as for basic interest rate swaps (fixed interest for variable interest for a notional amount and term). Block trading may be implemented using rules to limit the size of a block trade, as outside concerns suggest.

The platform may also allow implementation of switches, including calendar rolls, maturity switches, invoice spot switches, and/or other invoice switches. Such switches allow a platform user to “switch” positions based on the parameters of a present holding, such as an impending maturity date, or to maintain portfolio positions as on the run bonds to maximize liquidity. A calendar roll switch would implement selling/buying the active series invoice spread to buy/sell the next series while maintaining the same tenor. For example, FVH3-M3 would roll from the benchmark five year March to benchmark five year June Invoice spread. A notional display 300 for presentation to a first platform user identifying selection criteria for an invoice roll in which March bonds were to be rolled over to June bonds 302 for varying terms shown as the headings for the columns, with basis point offsets identified in the cells 304 associated with each tenor.

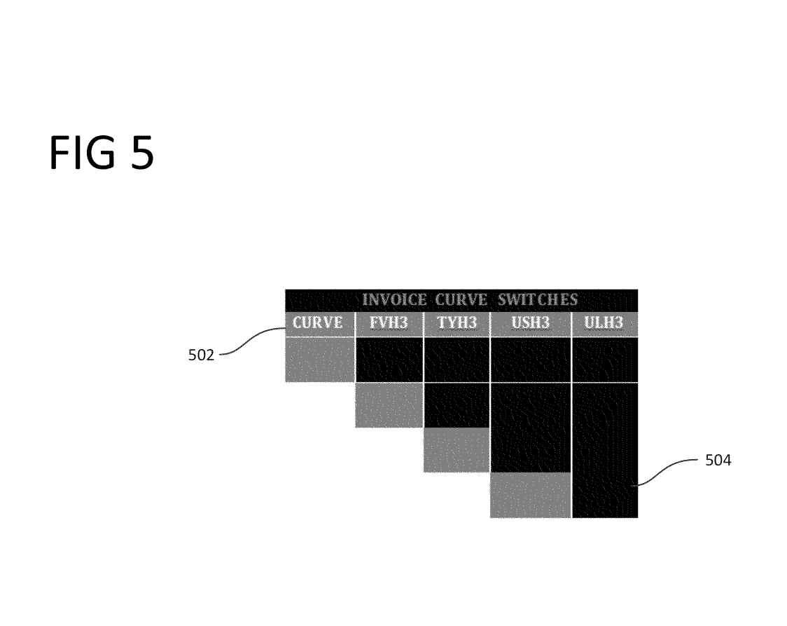

A maturity switch would be described as switching two different tenors of the same series. For example; selling FVH3 to buy TYH3 invoice spreads. An invoice spot switch may include a switch where one leg is an invoice spread and the other leg is a standard spot starting swap spread. These are generally done with nearby maturities such as TY Invoice vs 10 YR Spot or TY Invoice vs 7 YR Spot. Other invoice switches, such as a switch where underlying maturity and effective month are both different may also be implemented. FIG. 5 illustrates a notional display 500 for presentation to a first platform user identifying possible selections and basis point offsets for an invoice curve switch. Again, the potential bond positions are identified as column headers 502, with the potential basis point offsets identified in the cells 504 below each column.

Flys, including maturity flys and invoice-spot flys, may also be implemented relying on the conversion processing inherent in the platform process. A maturity switch could include selling FVH3, buying TYH3 and selling USH3 invoice spreads. Invoice spot flys could include any combination or mixed type spreads.

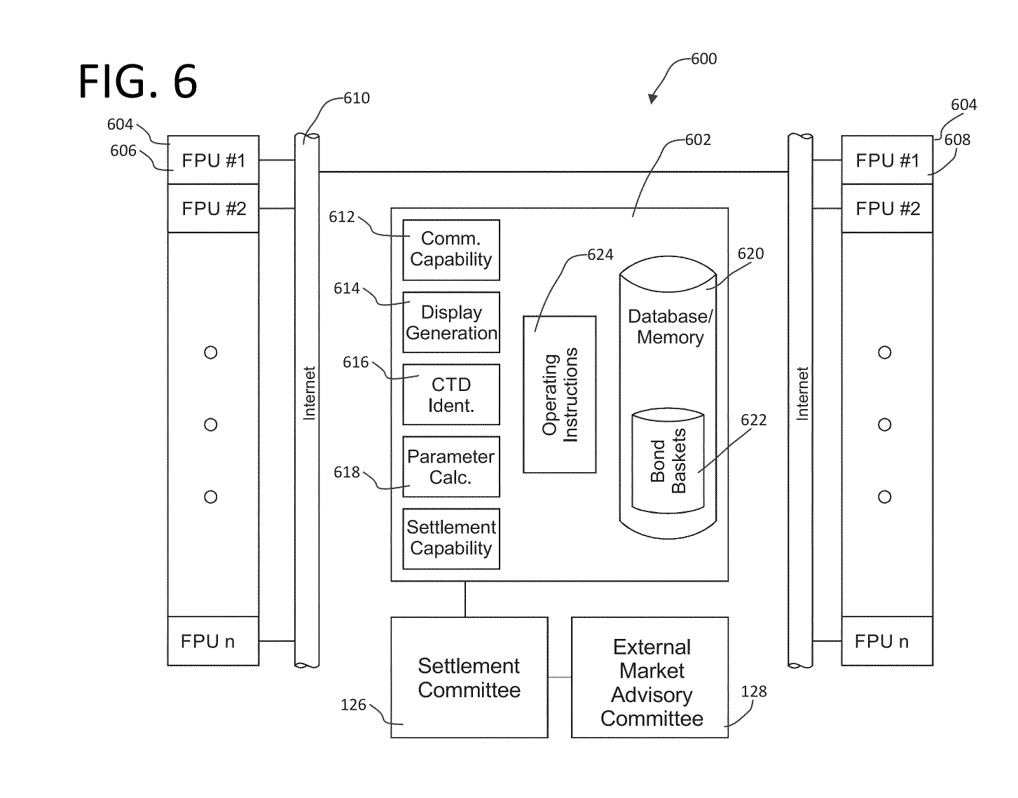

As is shown in FIG. 6, an embodiment of the present disclosure may be implemented in a network 600 allowing platform users to evaluate and implement invoice spread swaps. The major issue in evaluating invoice spread swaps is the ability to rapidly determine parameters associated with a potential position for an invoice spread swap, as well as the difficulty in identifying a counter party to the transaction.

The platform 602 may be communicably connected with a plurality of platform users. At any given time, those platform users 604 may be either requesters 606 or offerors 608 with respect to an invoice spread swap transaction, however for simplification here are referred to as first platform users 606 on the requesting side, and offering platform users 608 on the offering side. Offering platform 608 users may have a basket of bonds which they are willing to swap as part of an invoice spread swap. The communicable connection with the platform users 604 may be established through the internet 610, through a local network, through a publicly switched telephone network, or through whatever other communications connection is preferable for the particular implementation.

The platform itself may be implemented on a server having specific functionality, including a capability 612 for receiving and sending information to and from the platform users. The platform may also have a capability 614 for generating displays for platform users, including portfolio management tools, invoice spread swap transaction type requests and identifications, as well as a capability 616 for performing calculations to allow the platform not only to identify cheapest to delivery bonds, but to also calculate 618 DVO1 values for both the swap position and offered bond for a potential transaction, as well as to be able to normalize values for the swap position and offered bond.

The platform may also include a database 620 or other memory storage system allowing the platform to store information associated with the platform users, such as what positions are in their individual portfolios, routing information for settling transactions, and other parameters for the user as deemed beneficial to the platform operation. Within the database may additionally be information 622 identifying bond positions held by platform users offering bonds for inclusion in an invoice spread transaction.

The platform may be designed to implement the processes described above, through operating code 624 which controls the process. The platform may also include capabilities to allow the platform to also implement simple interest rate swap transactions and management functions as described in Applicant's earlier filed application, U.S. patent application Ser. No. 13/446,998, which is incorporated herein by reference thereto in its entirety.

As discussed above, where there is a lack of market activity at time of closing, a settlement committee, formed to establish switch levels of invoice spreads to relevant benchmark swap spreads, may poll an external market advisory council to provide disinterested values for the switch levels of invoice spreads to relevant benchmark swap spreads. The settlement may add these switch levels to benchmark swap spreads to come up with the daily settlements. In order to implement this capability, the platform may include a settlement committee as well as an external market advisory council, as well as communications links for communicating with these entities. The settlement committee and the external market advisory council may be implemented using the rules identified in the Method and System for Interest Rate Swaps disclosure incorporated hereto.

As well as the method and platform embodiments described above, the present disclosure may alternately be embodied in computer instructions which implement the above process, such that the instructions cause a computer having the necessary communications capabilities which is executing the instructions to perform the above method.

The present disclosure may be embodied in other specific forms without departing from the spirit or essential attributes of the disclosure. Accordingly, reference should be made to the appended claims, rather than the foregoing specification, as indicating the scope of the invention.

What is claimed is:

1) A computer implemented invoice spread swap process, comprising:
Establishing an invoice spread swap platform;
Communicably connecting a plurality of users to said invoice spread swap platform;
Receiving from at least one platform user at least one bond position available for execution as a counter position in an invoice spread transaction;
Displaying for a first platform user a query allowing said first platform user to select a type of potential invoice spread transaction that said platform user may desire to effectuate;
Receiving from said first platform user an invoice spread transaction type identifying a transaction type that said first platform user may desire to effectuate;
Displaying for said first platform user a plurality of potential basis point adjustments associated with a plurality of bond types for said transaction type;
Receiving from said first platform user identification of a desired basis point adjustment associated with a desired bond type for said selected transaction type;
Determining from said desired basis point adjustment associated with a desired bond type for said selected transaction type a cheapest to delivery bond for said bond type and transaction type;
Identifying a platform user offering said identified cheapest to delivery bond;
Determining for said cheapest to delivery bond parameters associated with the potential transaction;
Displaying for said first platform user said bond parameters associated with the potential transaction;
Querying said first platform user an indication as to whether said first platform user desires to effectuate a transaction involving said cheapest to delivery bond;
Communicating said proposed transaction to said offering platform user when said first platform user indicates that said first platform user desires to effectuate a transaction involving said cheapest to delivery bond;
Determining from said offering platform user whether said offering platform user desires to effectuate said transaction;
Notifying said first platform user that said offering platform user is willing to effectuate the transaction when said first platform user is willing to effectuate said transaction;
Determining from said offering platform user whether said offering platform user desires to substitute a different bond from a basket of deliverable bonds associated with said offering user when said offering platform user indicates that said offering platform user does not desire to effectuate said transaction;
Determining for said substitute bond parameters associated with the potential transaction;
Informing the first platform user that said offering platform user is willing to effectuate the transaction using said substitute bond, and displaying said parameters associated with said substitute bond, when said offering user desires to effectuate the transaction involving said substitute bond;
Determining from said first platform user whether said first platform user desires to confirm effectuation of said transaction when said offering platform user indicates a willingness to effectuate the potential transaction involving either said cheapest to delivery bond or a substitute bond;
Updating the transaction records and portfolio lists of said first platform user and said offering platform user to effectuate the transaction when said first platform user confirms effectuation of said transaction;
Settling the transaction through appropriate channels for said first platform user and said offering platform user.

2) A computer implemented invoice spread swap process according to claim 1, wherein said type of potential invoice spread transaction comprises a calendar roll transaction.

3) A computer implemented invoice spread swap process according to claim 1, wherein said type of potential invoice spread transaction comprises a maturity switch transaction.

4) A computer implemented invoice spread swap process according to claim 1, wherein said type of potential invoice spread transaction comprises an invoice spot switch transaction.

5) A computer implemented invoice spread swap process in accordance with claim 1, wherein said delivery bond parameters associated with the potential transaction comprise calculating a correction for the front coupon to accommodate an initiation date other than the current date.

6) A computer implemented invoice spread swap process in accordance with claim 1, wherein said delivery bond parameters associated with the potential transaction comprise calculating a par swap DVO1 for the CTD product; and calculating a swap notional by dividing the bond DVO1 by the swap DVO1.

7) A computer implemented invoice spread swap process in accordance with claim 1, wherein determining said delivery bond parameters associated with the potential transaction comprise determining from a settlement committee switch levels of invoice spreads to relevant benchmark swap spreads.

8) A computer implemented invoice spread swap process in accordance with claim 7, wherein said settlement committee, formed to establish switch levels of invoice spreads to relevant benchmark swap spreads, polls an external market advisory council to provide disinterested values for the switch levels of invoice spreads to relevant benchmark swap spreads.

9) A computer-implemented invoice spread swap platform comprising a computer system that includes:
a communications capability to communicate with a plurality of platform users;
a capability for generating displays for platform users, said capability including the capability to generate displays identifying potential bonds for implementation in an invoice spread swap;
a capability for performing calculations to identify a cheapest-to-delivery bond from a basket of bonds available for implementation in an invoice spread swap;
a capability for performing calculations to calculate DVO1 values for both the swap position and the offered bond;
a database for storing information associated with said platform users, said database comprising information identifying bond positions held by platform users offering bonds for inclusion in an invoice spread transaction; and
a capability for settling transactions desired to be effectuated between a first platform user and an offering platform user.

10) A computer-implemented invoice spread swap platform according to claim 9, wherein the offering platform user is the platform operator.

11) A computer-implemented invoice spread swap platform according to claim 10, further comprising a settlement committee for establishing switch levels of invoice spreads to relevant benchmark swap spreads.

12) A computer-implemented invoice spread swap platform according to claim 11, further comprising an external market committee, wherein, said settlement committee polls said external market advisory council to provide disinterested values for the switch levels of invoice spreads to relevant benchmark swap spreads.
